(19) United States
(12) Patent Application Publication
(10) Pub. No.: US 2010/0265850 A1
(43) Pub. Date: Oct. 21, 2010

(54) MULTIPURPOSE DUAL-NETWORK ROUTER

(76) Inventor: Sheng-Jung Chiang, Kaohsiung City (TW)

Correspondence Address: Guice Patents PLLC, 12647 Galveston Court #302, Manassas, VA, 20112, US

(21) Appl. No.: 12/427,073

(22) Filed: Apr. 21, 2009

(51) Int. Cl. H04L 12/16

(52) U.S. Cl. 370/270

(57) ABSTRACT

A multipurpose dual-network router includes a housing that houses a motherboard formed of a PC board carrying a set of electronic devices, a power module and an antenna module. The motherboard is connectable to the internet and PSTN, providing data group filtering, data group forwarding, call-waiting priority leveling, encryption, compression and firewall functions and having multiple ports for the connection of one or a number of same or different applicable products, each port having an ID set subject to TCP/IP for interlinking, function switching or dialing a call. When connected to the internet and PSTN, multiple main units are allowed for one-way direct call. Thus, one single module of the invention provides stronger function than a combination of conventional products.

### BACKGROUND OF THE INVENTION

1. Field of the Invention

The present invention relates to a router main unit and more particularly, to a multipurpose dual-network router. When multiple multipurpose router main units are connected to the internet and PSTN, they can dial a call to one another.

2. Description of the Related Art

Conventionally, network linking is done by means of connecting a network line from a PSTN to a modem and then connecting the modem to an internet tool, for example, computer, and then to start download link on a platform provided by a system provider. When a network switching function is necessary, a network switching system must be connected.

Further, regular internet phone, such as Skype, msn, and QQ, is a computer-to-computer design. An advanced design uses a USB phone. A USB phone is shaped like a conventional telephone and operated in a manner similar to the conventional telephone dialing habit. However, these conventional designs are for on-net call only, not allowed for extranet call (for example, Skype to QQ). When an extra communication is needed, related communication hardware and software must be added to the computer.

FIG. 1 shows that one computer (user A) cannot direct call another computer (user B) (extranet call). For a dialing a call between the two computers, it must be done through a third party like Skype, msn or QQ (Skype is shown as an example), or a communication software. These all pertain to internetwork communication.

A telephone set is a communication product for dialing a call. A small computer is a computer convenient for carrying. A network tool, for example, a router is a network peripheral product for a specific application.

When wishing to add an extra function to conventional network products, extra equipment such as router or gateway must be used to expand the function. Network peripheral equipments are to be the same. For example, network fax, network surveillance equipment or video conference equipment must be connected in series or in parallel to provide a certain function for resource sharing or private service.

When distributed hosting is adopted, the aforesaid equipment stacking problem is eliminated. The invention uses a single-piece multipurpose system main unit that is a combination of multiple functions. Sub-units that are to be connected to the main unit are separately made to fit user's requirements. Subject to functions required, one single or multiple sub-units are connected to the main unit. Simplification lowers the cost. A user can add an extra product subject to every extra function required. For example, when only e-mail and network call functions are required, a modem, a computer, a keyboard, a display, a communication software, an earphone and a microphone are needed to achieve the functional requirements according to conventional techniques. However, to satisfy this requirement, the invention simply needs a modem, a keyboard, a display, an earphone and a microphone.

Using the present invention satisfies all requirements. By means of using a conventional telephone set with one router connected to an applied product, the invention provides functions of multiple products, saving much equipment investment. Subject to functional requirements, the invention provides a user with a wonderful product with low price and good quality.

### SUMMARY OF THE INVENTION

The present invention has been accomplished under the circumstances in view. It is the main object of the present invention to provide a multipurpose dual-network router main unit includes a housing that houses a motherboard formed of a PC board carrying a set of electronic devices, a power module and an antenna module. The motherboard is connectable to the internet and PSTN, providing data group filtering, data group forwarding, call-waiting priority leveling, encryption, compression and firewall functions and having multiple ports for the connection of one or a number of same or different applicable products, each port having an ID set subject to TCP/IP for interlinking, function switching or dialing a call. When connected to the internet and PSTN, multiple main units are allowed for one-way direct call. Thus, one single module of the invention provides stronger function than a combination of conventional products.

Further, the multipurpose dual-network router main unit of the invention is a combination of a conventional telephone set, a small computer, an internet router and a gateway (gateway is a software for switching between different protocols), so that the main unit can function as a telephone switching system, a video network switching system, a system for communication with a cell phone or an on-net telephone or extranet telephone (network to PSTN). This multipurpose product allows multiple persons to share its functions.

Further, the multipurpose dual-network router main unit of the invention is modified from a conventional router, adopting a general public system software, such as Linux, or commercial system software, such as Windows. The main unit uses Advanced RISC Machine (ARM) IC chips that obtain a part of the function of a modern computer under the use of C programming language. It involves Session Initiation Protocol (SIP) IP telephone (VOIP technology, the function of performing the conversion PSTN signaling protocols and IP telephone subject to MGCP (Media Gateway Controller Protocol) technology, the function of ID establishment, the function of video and voice calling, and the functions of data group filtering, group forwarding, priority leveling, encryption, compression and firewall of a regular router, and the function of internet connection, communication, video transmission or display connection.

### BRIEF DESCRIPTION OF THE DRAWINGS

FIG. 1 is a schematic drawing showing a conventional computer-to-computer voice communication architecture.

FIG. 2 illustrates the architecture of a multipurpose dual-network router according to the present invention.

FIG. 3 is an exploded view of the multipurpose dual-network router according to the present invention.

FIG. 4 is an elevational assembly view of the multipurpose dual-network router according to the present invention.

FIG. 5 illustrates an application example of the present invention, showing the multipurpose router main unit used as a conventional telephone main unit.

FIG. 6 illustrates another application example of the present invention, showing the multipurpose router main unit used as a main unit of a conventional telephone switching system.

FIG. 7 illustrates still another application example of the present invention, showing the multipurpose router main unit used as a main unit of a telephone switching system with dual mode network function connectable to the internet.

FIG. 8 illustrates still another application example of the present invention, showing the multipurpose router main unit used as a main unit of a telephone switching system with dual mode network and video mode function.

FIG. 9 illustrates still another application example of the present invention, showing the multipurpose router main unit used as a multipurpose small computer with video mode and dual mode internet phone switching functions.

FIG. 10 illustrates still another application example of the present invention, showing the multipurpose router main unit used as a multipurpose small computer with video mode, remote surveillance and dual mode internet phone switching functions.

FIG. 11 illustrates still another application example of the present invention, showing the multipurpose router main unit used as a multipurpose small computer with video mode, surveillance and dual mode internet phone switching functions.

FIG. 12 illustrates an architecture of one-way direct call between two multipurpose router main units for dual-network communication according to the present invention.

FIG. 13 illustrates a on-net call architecture according to the present invention.

FIG. 14 illustrates an extranet call architecture according to the present invention.

FIG. 15 illustrates an architecture of a different application example of the present invention.

FIG. 16 illustrates an architecture of another different application example of the present invention.

FIG. 17 illustrates a telephone network architecture formed of multiple multipurpose dual-network routers according to the present invention.

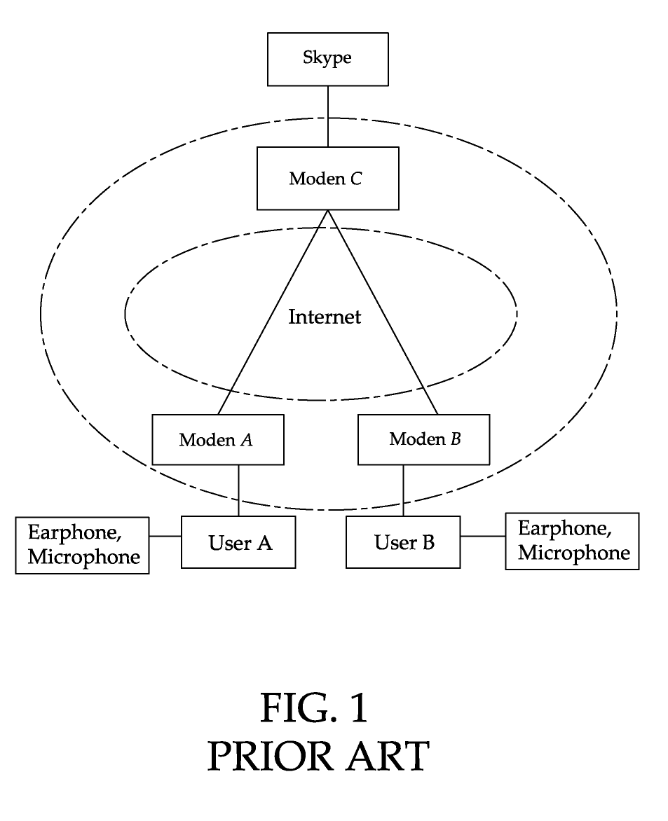

### DETAILED DESCRIPTION OF THE PREFERRED EMBODIMENT

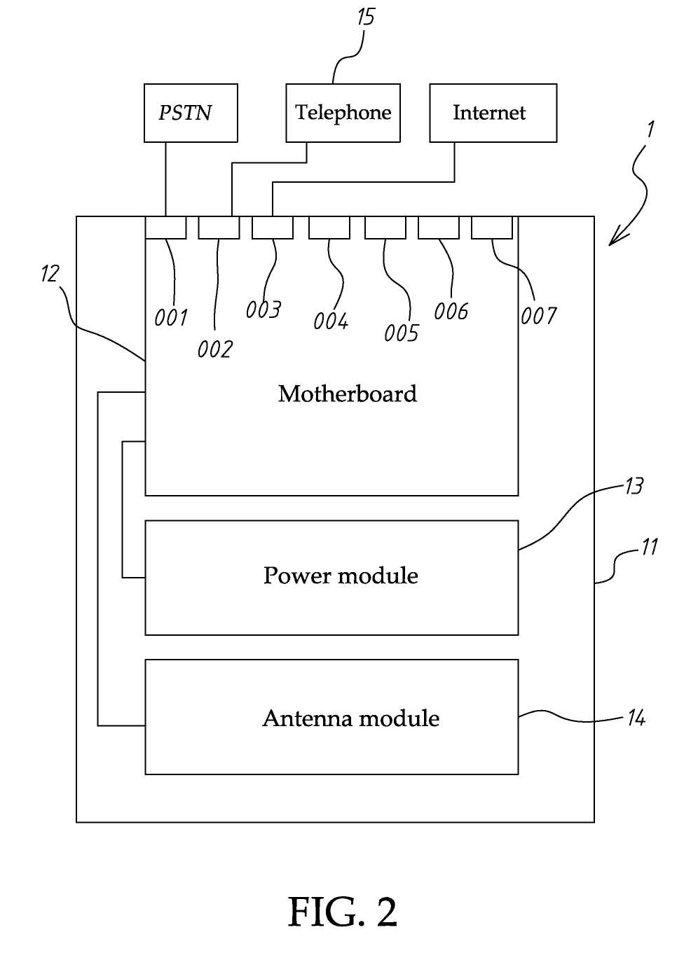

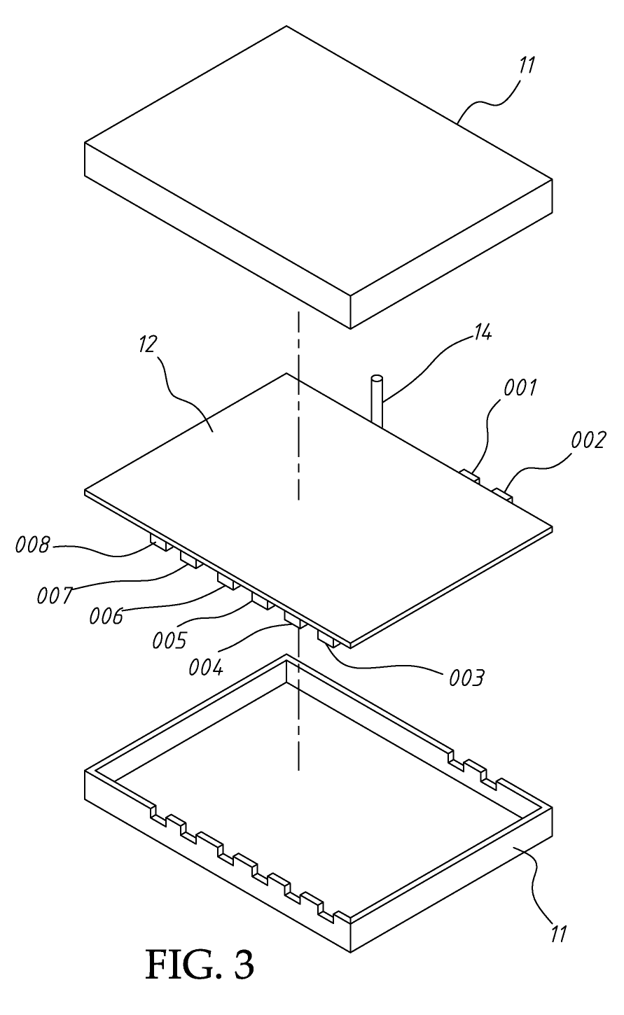

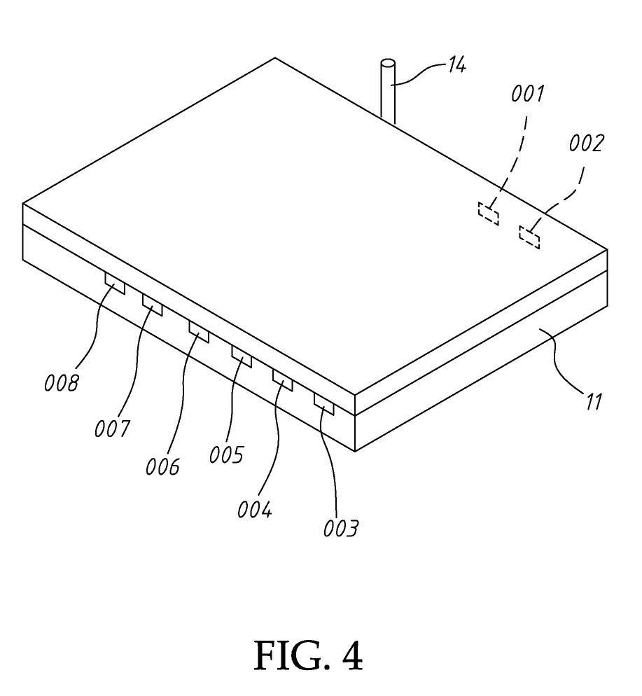

Referring to FIGS. 2˜4, a multipurpose router main unit 1 for dual-network communication according to the present invention is shown comprising a motherboard 12, a power module 13, an antenna module 14, and a housing 11 that houses the motherboard 12, the power module 13 and the antenna module 14.

The motherboard 12 is a PCB (printed circuit board) carrying multiple electronic devices. The PCB of the motherboard 12 can be a multi-layer PCB connectable to the Internet and PSTN (Public Switched Telephone Network), providing data group filtering, data group forwarding, call-waiting priority leveling, encryption, compression and firewall functions. The motherboard 12 has multiple ports 001˜008 for the connection of one or a number of same or different applicable products. Each port has an ID set subject to TCP/IP for interlinking, function switching or dialing a call.

The ID of each port of the motherboard is composed of at least one number, letter, sign or pattern.

Further, the power module 13, can be, for example, formed of a battery adapted to start up the motherboard 12.

Further, the housing 11 can be a single piece member or multi-piece member made of a metal or nonmetal material.

When compared to conventional computer products, the multipurpose router main unit 1 is an internet tool, and the motherboard 12 provides wireless internet, router, network video phone, remote surveillance and small computer functions. A small computer is functioning as a conventional personal computer, however it functions relatively simpler.

The ports 001˜008 of the motherboard 12 function like the connectors of a computer for the connection of peripheral apparatus, for example, a display device.

Referring to FIG. 2, the first port 001 of the motherboard 12 is an entry for a telephone line for connection to PSTN (Public Switched Telephone Network). The telephone line is obtained from PSTN provider with an attached telephone number. The second port 002 is for the connection of a conventional telephone set for dial call. The third port 003 is an entry for connection to the internet through a network line obtained from an internet service provider with attached e-mail address and ID.

The other ports 004˜007 are similar to the peripheral connectors of a computer for the connection of peripheral devices such as telephone set, camera, cell phone, computer and etc.

Every conventional computer has an IP address (0.0.0.0˜255.255.255.255). Doman name address, IP address and MAC address are commonly used for connection. Network connection is performed subject to TCP/IP (Transmission Control Protocol/Internet Protocol. Subject to TCP/IP and the related path, a computer knows where the data is to be sent. Through an internet service provider, a local computer can send data to a remote computer (for example, Skype; a person skilled in the art can use Skype to link to MSN). For example, when four computers A, B, C and D are connected to the internet through a wireless router and when wishing to set up a local area network to link every of the four computers for direct message transfer or call among the computers, set the IP address of computer A to be 192.168.1.1, computer B to be 192.168.1.2, computer C to be 192.168.1.3 and computer D to be 192.168.1.4. Thus, the computers A˜D can visit one another by means of the respective IP address. Through a simple modification, a telephone set can be used to dial “1”, “2”, “3” or “4” and to start the call. Because this technique is of the known art, no further detailed description in this regard is necessary.

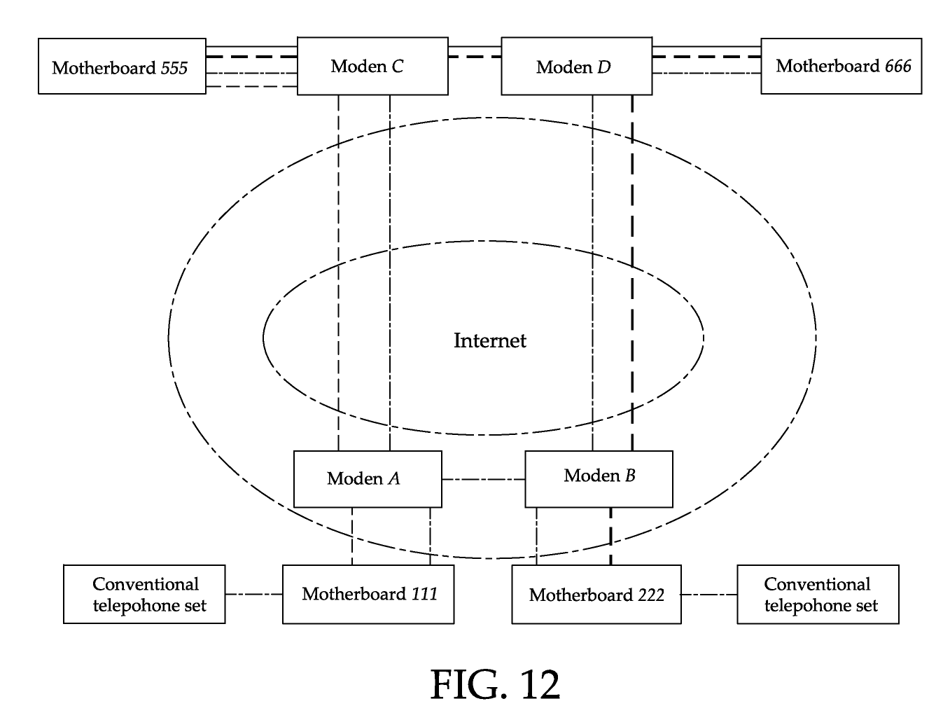

The multipurpose router main unit 1 can be used as a dual mode network router. A call code can be set in the multipurpose router main unit 1 for the path from the transmitter end to the receiver end. For example, # and 111 are set as the call code and index for the multipurpose router main unit respectively. In this case, the name of the multipurpose router main unit is changed to internet main unit #111, and ports 004, 005, 006 and 007 are sub-units each having a respective sub-unit ID “*” and index 004, 005, 006 or 007 respectively. Thus, the names of the ports 004, 005, 006 and 007 are changed to #004, #005, #006 and #007 respectively. This combination is named as Network dial and call main unit #111, hereinafter called as main unit #111. At this time, the main unit #111 provides network linking and telephone switching functions. Subject to the aforesaid operation method, main unit #222, main unit #555 and main unit #666 can be provided (see FIG. 12).

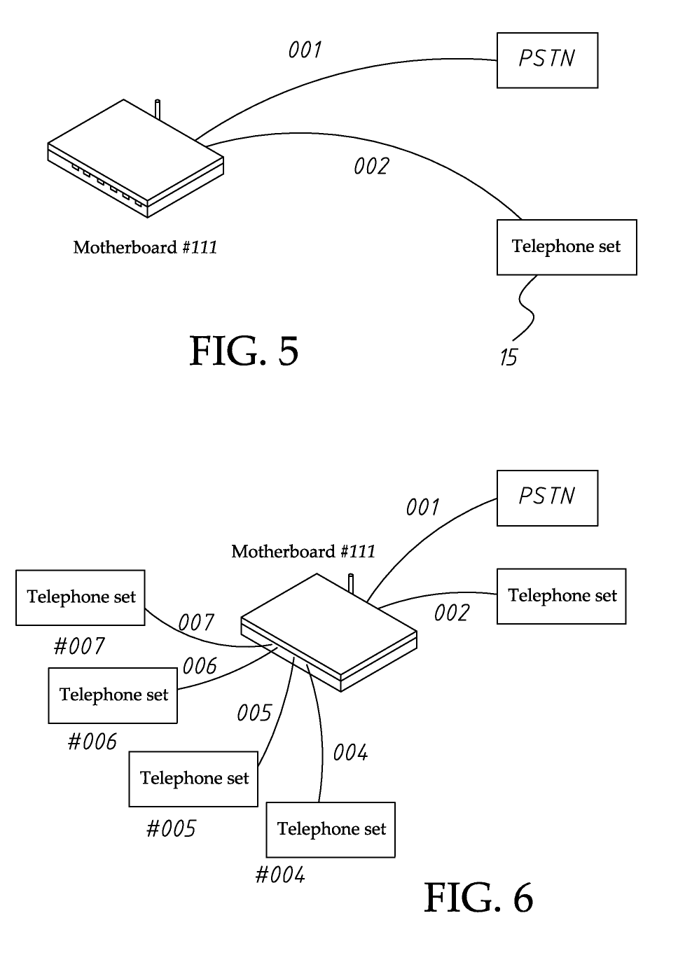

Referring to FIG. 5, when the port 001 and port 002 of the main unit #111 are respectively connected to PSTN and a telephone set 15, the main unit #111 can thus be used to dial a telephone number.

Referring to FIG. 6, if the sub-unit addresses #004, #005, #006 and #007 are respectively connected with a respective telephone set, the main unit #111 and the sub-units *004, *005, *006, *007 can call one another, keeping the conventional communication habit, for example, the main unit #111 can dial *004, *005, *006 or *007 to talk to the corresponding sub-unit. If the sub-unit *004 is going to call the sub-unit *005, pick up the telephone of the sub-unit *004 and dial *005 for talk. Communication between other sub-units is operated in the same manner. Thus, no further detailed description in this regard is necessary. To call the main unit from one sub-unit, dial #111. Like conventional habit in using a telephone to dial a call, it is simply to add # or *. Thus, the main unit is converted from the type that simply can dial a call to a telephone switching type main unit #111 that allows on-net call. This main unit is called hereinafter as telephone switching main unit #111.

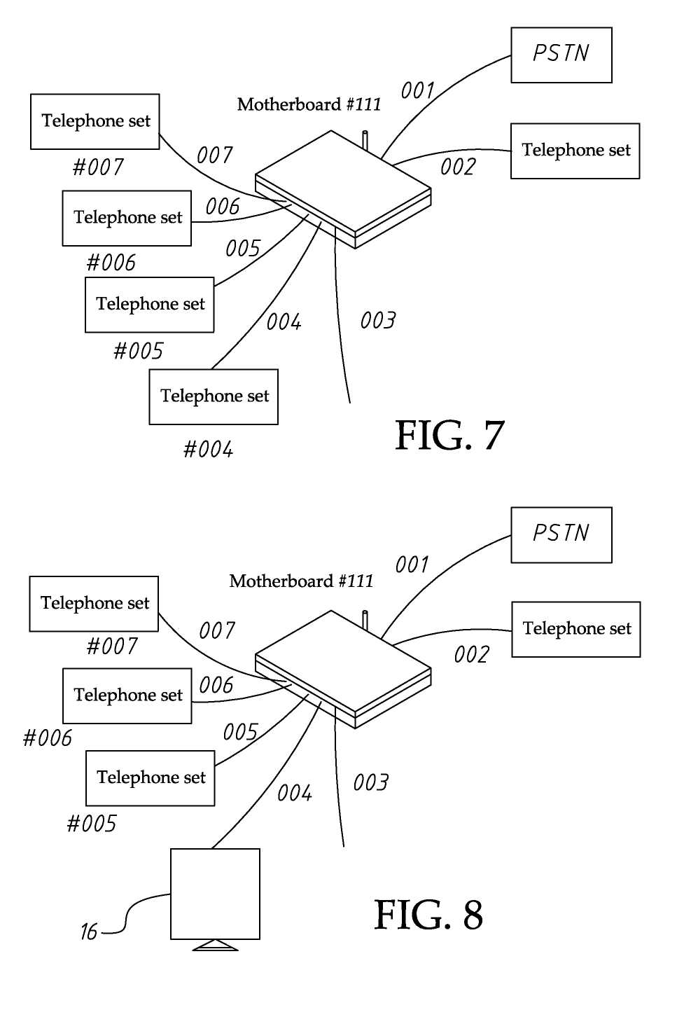

Referring to FIG. 7, when the port 003 of the telephone switching main unit #111 is connected to the internet through a line provided by PSTN and powered, the telephone switching main unit #111 will be upgraded to a telephone switching type main unit with internet and dual mode network functions, hereinafter called as a dual mode internet phone switching main unit #111.

Referring to FIG. 8, when disconnect the sub-unit*004 from the dual mode internet phone switching main unit #111 and connect a webcam display device to the dual mode internet phone switching main unit #111 as a substitute, the dual mode internet phone switching main unit #111 is further upgraded to a video dual mode internet phone switching main unit #111.

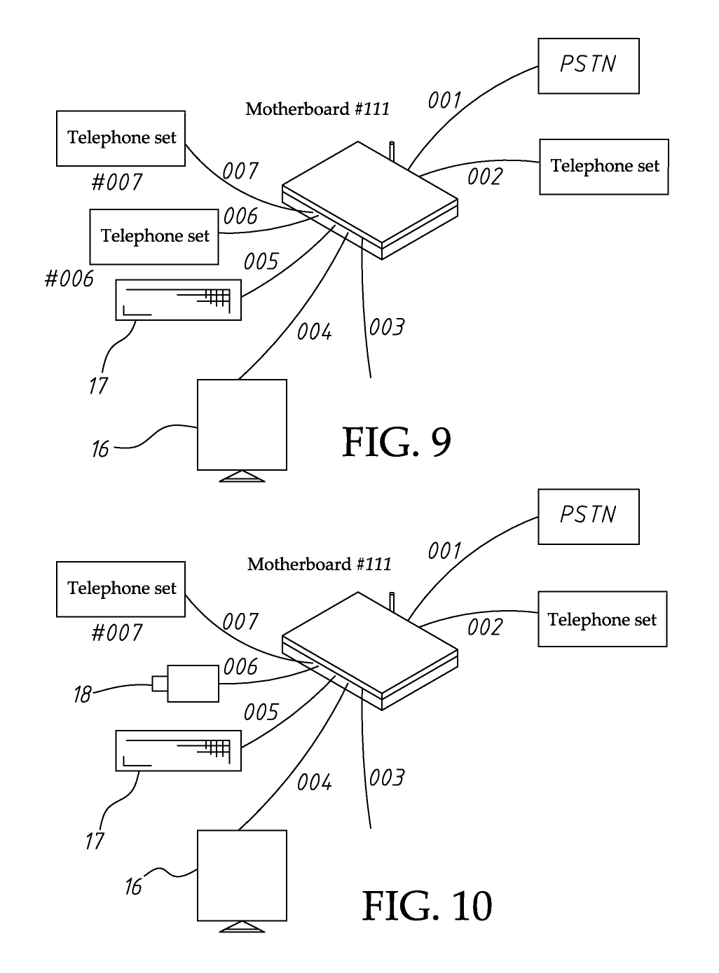

Referring to FIG. 9, when disconnect the sub-unit*005 from the video dual mode internet phone switching main unit #111 and connect a keyboard to the video dual mode internet phone switching main unit #111 as a substitute, the video dual mode internet phone switching main unit #111 is further upgraded to a small computer of video dual mode internet phone switching main unit #111.

Referring to FIG. 10, when disconnect the sub-unit*006 from the small computer of video dual mode internet phone switching main unit #111 and connect a camera 18 to the small computer of video dual mode internet phone switching main unit #111 as a substitute, the small computer of video dual mode internet phone switching main unit #111 is further upgraded to a small computer of video dual mode network surveillance telephone switching main unit #111.

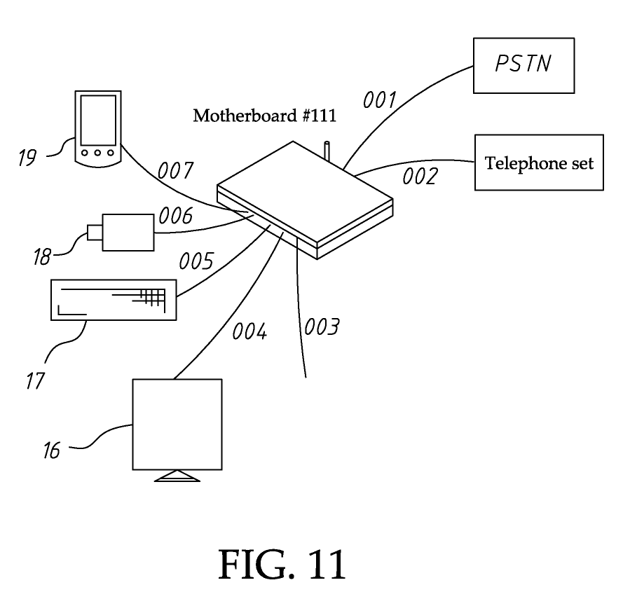

Referring to FIG. 11, when disconnect the sub-unit*007 from the small computer of video dual mode network surveillance telephone switching main unit #111 and connect a cell phone 19 to the small computer of video dual mode network surveillance telephone switching main unit #111 as a substitute, the small computer of video dual mode network surveillance telephone switching main unit #111 has an added function to communicate with a mobile telephone and to share all the resources of the sub-units. In conclusion, one main unit allows making an extranet call, and can be attached with one or a number of sub-units to provide one or multiple added functions.

Referring to FIG. 12, two main units #111 and #222 can be respectively connected to the internet and then linked. When the main unit #222 is in connection with the main unit #111 over the internet, a user of the main unit #111 can pick up the telephone and dial the number #222 to call the user of the main unit #222 for talk. A sub-unit of a local main unit can all a sub-unit of a remote main unit by dialing the number of the remote main unit+the number of the respective sub-unit.

The operation is outlined hereinafter. If the sub-unit *008 of the main unit #111 is going to call the sub-unit *007 of the main unit #222, the caller, i.e., the sub-unit *008 can dial #222*007 for talk. Calling between others is done in the same way. A sub-unit of a main unit can call another main unit simply by dialing #XXX.

By means of the single or multiple ports of the main unit any functional product can be added subject to carrier bandwidth (1M=1000K), providing an extra function. When there is no real time data requirement, there will be no bandwidth limitation. The minimum bandwidth is 16 Kbps for voice signaling. However, 32 Kbps is better. For video signaling, 150 K bytes/sec or 1200 K bits/sec is required.

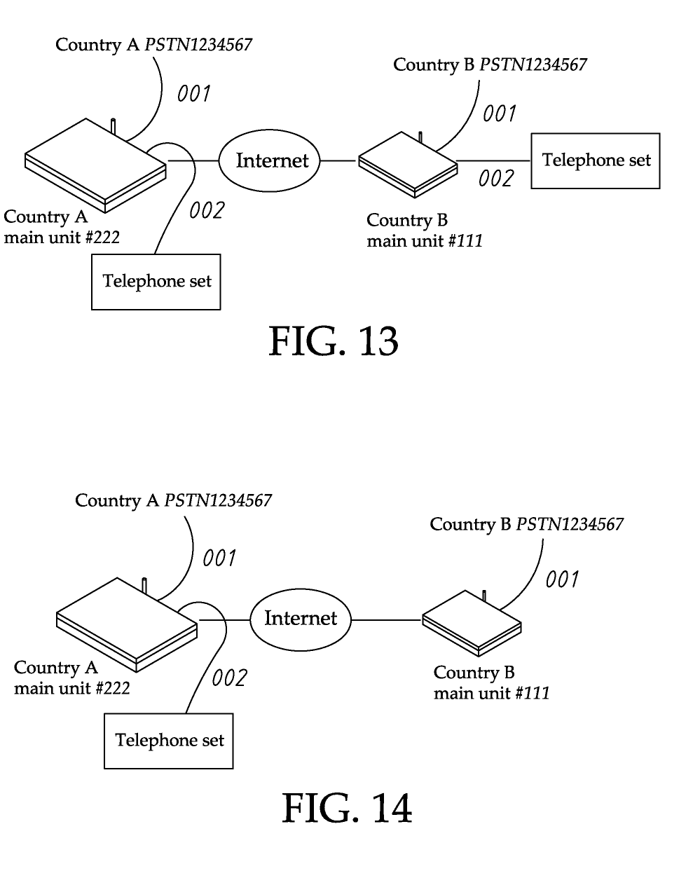

A further advantage of the present invention is shown in FIG. 13. When the first port 001 of a main unit #111 used in Taiwan is connected to the local PSTB under the telephone number 1234567 and the second port 002 of the main unit #111 has a telephone set connected thereto, the telephone set can be picked up to call a local telephone, for example, the number 7654321 directly for talk (this is an on-net call). When calling the same telephone number in China, dial the number +86 1234567 for talk (this is an extranet call). If the first port 001 of main unit #222 used in China is connected to the local PSTN under the telephone number 1234567 and the second port 002 of the main unit #222 has a telephone set connected thereto, picking up the telephone and dialing the telephone number 7654321 can talk to the user of the telephone number 7654321 in China but cannot talk to the user of the telephone number 7654321 in Taiwan. When the main unit #11 in Taiwan and the main unit #222 in China both are connected to the internet, the user of the main unit #222 can pick up the telephone at the second port 002 and dial #111 to communicate with the telephone at the port 002 of the main unit #111 in Taiwan (see FIG. 13). This is an on-net call. Regular internet phones are of this function. When pick up the telephone 1234567 at the second port 002 of the main unit #222 in China and dial #111*002 after disconnection of the telephone from the second port 002 of the main unit #111 in Taiwan, it is connected to the PSTN of 1234567, and the main unit #111 in Taiwan is applicable for dialing any telephone number in Taiwan. When using the telephone at the second port 002 of the main unit #222 in China to dial the telephone number 7654321, the telephone 1234567 in China is in communication with the telephone 7654321 in Taiwan (see FIG. 14). This is an extranet call.

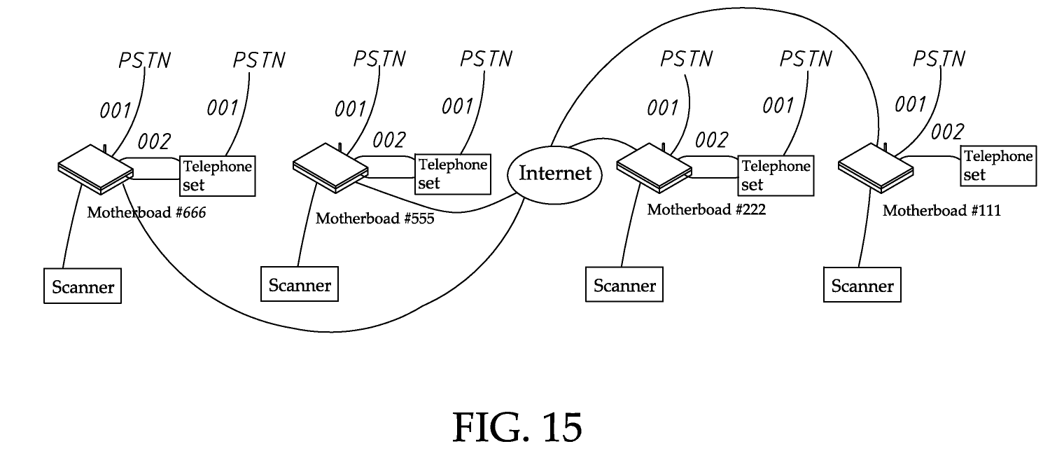

Referring to FIG. 15, in an application example of the present invention, four sub-units are respectively connected to main units #111, #222, #555 and #666. The owner of the main unit #111 is a product provider who sends a product with a label carrying the data of product name, manufacturing date, weight and/or quality to an examination unit who uses the main unit #222 for examination. The examination unit can use a sub-unit (scanner) of the main unit #222 to scan the data from the label of the product, obtaining the desired information. After examination, the examination unit attaches a label with examined data to the product when the product passed the examination, or returns the product to provider if the product did not pass the examination. The qualified product can then be sent to a distributor center for sale. The distributor uses the main unit #555 to scan the label that is attached to the product by the provider and the label that is attached to the product by the examiner, obtaining the necessary information. The distributor can then attach a label carrying the data of expiring date to the product. By means of scanning the label, the distributor knows whether or not the product is expired, facilitating inventory control. A consumer who purchased the product can use the main unit #666 to scan the labels of the product, obtaining all product information from the manufacturing end to the examination end and the distributor end, and assuring quality of purchased product (see FIG. 15).

The above explanation simply describes one application example of the present invention. The spirit of the present invention is a systematic design from the start end to the intermediate linking end and the terminal end created from the angle of consumer to provide practical functions subject to different requirements. The function integration of the present invention can substitute for the combination of two computers and the related displays, keyboards, internet phones, network switching devices, network gateways, set-top boxes and network surveillance systems. Unlike regular products that provide multiple added functions that may be not usable to the consumer who purchased the products, the invention is a vertical integration (see the architecture shown in FIG. 12) that satisfies consumers' actual requirements.

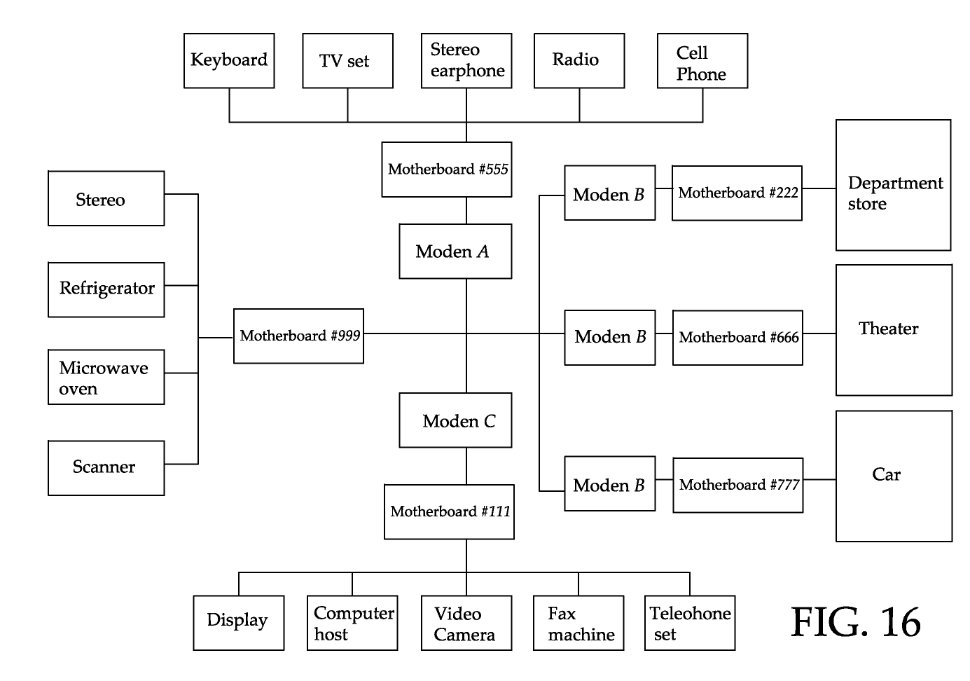

When the main unit reaches the function limitation, a user can set an extra main unit #777 in a vehicle for connection to the internet or dialing a call, and set another extra main unit #999 in home to connect all the electric appliances for remote control (see the architecture shown in FIG. 16). Thus, three main units are distributed in different places but linked together through the internet. This arrangement eliminates the drawback of conventional techniques using a big number of equipments to achieve same functions.

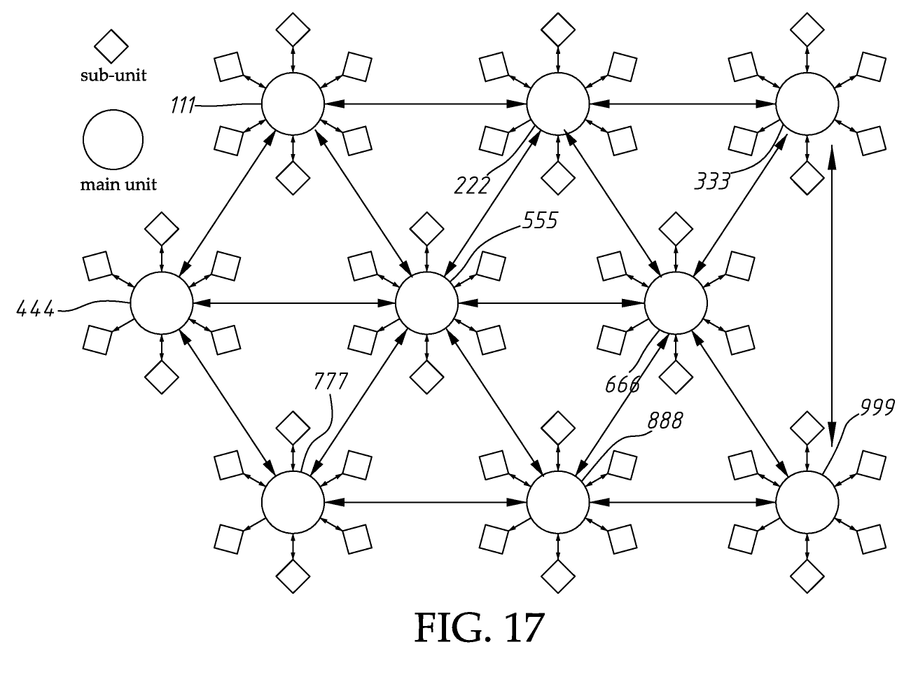

FIG. 17 illustrates a telephone network architecture formed of multiple multipurpose dual-network routers according to the present invention in which the circle represents a main unit; the rhombus represents a sub-unit). Multiple main units 111˜99 each having connected thereto multiple sub-units are linked together, constituting a telephone network. Every sub-unit of every main unit can call any main unit or any sub-unit of any main unit in the telephone network.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A multipurpose dual-network router, comprising:
a motherboard formed of a printed circuit board carrying a set of electronic devices and connectable to the Internet and PSTN (Public Switched Telephone Network) and providing data group filtering, data group forwarding, call-waiting priority leveling, encryption, compression ad firewall functions, each said motherboard having a plurality of ports on one end thereof for the connection of applicable products, each said port having an ID set subject to TCP/IP for interlinking, function switching or call between the respective port and the connected product;
a power module adapted to provide power for starting up said motherboard;
an antenna module connected to said motherboard to receive and transmit signal wirelessly; and
a housing that houses said motherboard, said power module and said antenna module.

2. The multipurpose dual-network router as claimed in claim 1, wherein the printed circuit board of said motherboard is a multilayer design.

3. The multipurpose dual-network router as claimed in claim 1, wherein each said port of said motherboard generates an ID code composed of at least one number, letter, sign or pattern.

4. The multipurpose dual-network router as claimed in claim 1, wherein said housing is formed of multiple parts.

5. The multipurpose dual-network router as claimed in claim 1, wherein said housing is made of a metal material.

6. The multipurpose dual-network router as claimed in claim 1, wherein said housing is made of a nonmetal material.

7. The multipurpose dual-network router as claimed in claim 1, wherein said power module is comprised of a battery set.

8. The multipurpose dual-network router as claimed in claim 1, wherein each said port of said motherboard is a wireless communication port.
